(19) United States
(12) Patent Application Publication
(10) Pub. No.: US 2008/0070528 A1
(43) Pub. Date: Mar. 20, 2008

(54) Mid-Call Features

(76) Inventors: Tom Joyner, Chicago, IL (US); James D. O'Brien, East Weymouth, MA (US); Harry Edward Mussman, Bedford, MA (US)

Correspondence Address: FISH & RICHARDSON PC, P.O. BOX 1022, MINNEAPOLIS, MN, 55440-1022, US

(21) Appl. No.: 11/533,155

(22) Filed: Sep. 19, 2006

(51) Int. Cl. H04B 1/18

(52) U.S. Cl. 455/187.1

(57) ABSTRACT

A mid-call feature of a voice call server, such as an IP PBX or IP Centrex system, is accessed during a call. During the call with a mobile terminal via a mobile telephone network, a voice call signal associated with a mid-call feature from the mobile terminal is passed over a mobile telephone network to a first communication system. The voice call signal is converted to a data call signal at the first communication system, and the data call signal is transmitted to a second communication system over the data network. The method can also include providing the mid-call feature in response to receipt of the data signal at the second communication system.

### CROSS-REFERENCE TO RELATED APPLICATIONS

This application is related to U.S. application Ser. No. 11/492,698, filed on Jul. 25, 2006, titled “Mobile and Packet-Based Call Control,” and to International Application PCT/US2006/028755 also filed on Jul. 25, 2006. These applications are incorporated herein by reference.

### BACKGROUND

This invention relates to mid-call features in a telephone communication system.

Many telephone systems provide users with mid-call features that may be invoked while a call is in progress. For example, in a telephone system using a convention Private Branch Exchange (PBX), a user may press a “hook flash” button on their telephone set (terminal) that is detected by the PBX. Examples of a mid-call feature include establishment of a three-way call, call transfer, and answering or other disposition of an second incoming call.

CMDA and GSM cellular telephone systems also provide some mid-call features. For example, in some systems a second inbound call may be answered by a user, by pressing the “Call” button on a mobile telephone and the subscriber can toggle between the two calls with the cellular telephone system switching the call that is sent to the user's telephone. Similarly, in some systems, a user may establish a multiple-party conference during an existing call by dialing and pressing the “call” button.

Some telephony systems also provide access to mid-call features by monitoring the audio signal passing from a telephone to detect signaling tones (i.e., dual-tone multiple frequency, DTMF).

### SUMMARY

In one aspect, in general, a mid-call feature of a voice call server, such as an IP PBX or IP Centrex system, is accessed during a call. During the call with a mobile terminal via a mobile telephone network, a voice call signal associated with a mid-call feature from the mobile terminal is passed over a mobile telephone network to a first communication system. The voice call signal is converted to a data call signal at the first communication system, and the data call signal is transmitted to a second communication system over the data network.

Aspects can include one or more of the following features.

The method also includes providing the mid-call feature in response to receipt of the data call signal at the second communication system.

Passing the voice call signal from the mobile terminal to the first communication system includes passing a signal for establishing a multiparty call from the mobile terminal to the mobile telephone network.

Passing the voice call signal from the mobile includes receiving the signal for establishing a multiparty call and notifying the first communication system.

Passing the voice call signal from the mobile terminal to the first communication system includes passing a short message service (SMS) message from the mobile terminal to the first communication system.

Passing the voice call signal from the mobile terminal to the first communication system includes passing a GSM unstructured supplementary services data (USSD) message from the mobile terminal to the first communication system.

The first communication system includes a gateway between the voice network and the data network.

The second communication system includes one of a private branch exchange system (PBX), an IP-based PBX, an IP Centrex, and a softswitch.

The data call signal includes a Session Initiation Protocol (SIP) message.

The voice call signal associated with a mid-call feature includes at least one of an IS-41 and a Wireless Intelligent Network (WIN) signal.

The voice call signal associated with a mid-call feature includes at least one of an GSM MAP, a GSM CAMEL, and a GSM USSD signal.

In another aspect, in general, a system includes a first communication system configured to receive over a mobile telephone network, during a call with a mobile terminal via a mobile telephone network, a voice call signal associated with a mid-call feature from the mobile terminal. The first communication system is also configured to convert the voice call signal to a data call signal and to transmit the data call signal to a second communication system over a data network.

The system can also include the second communication system, which is configured to provide the mid-call feature in response to receipt of the data call signal.

In another aspect, in general, software stored on a computer-readable medium includes instructions for causing a processing system to process a voice control signal received over a mobile telephone network, during a call with a mobile terminal via a mobile telephone network. The voice call signal is associated with a mid-call feature from the mobile terminal. The processing of the voice control signal includes converting the voice call signal to a data call signal and transmitting the data call signal to a second communication system over a data network.

Advantages can include one or more of the following.

Every call does not requires constant monitoring of DTMF digits, for the relatively few calls that require action. Because the NCG does not have to be in the media stream for a call, extra call legs through dedicated media servers, which can add cost and complexity, may be avoided.

Digit strings entered by users for mid-call features do not have to be long enough and unique enough to avoid confusion with other DTMF sequences that might occur during a call (e.g. access of Voice Mail system). Long DTMF sequences, which may be hard to remember could required client software to signal the sequences, and such associated client software therefore may be avoided. Shorter digit sequences also take less time to send, thereby reducing delays between the request and the server's response.

Other features and advantages of the invention are apparent from the following description, and from the claims.

### DRAWINGS

FIG. 1 is a block diagram of a communication system.

FIGS. 2-6 are signal timing diagrams.

### DESCRIPTION

One or more implementations of communication systems described in the Appendix provide telephone services to users at terminals 110, which are serviced though a mobile telephone system that includes a mobile backbone 120, by a voice server 154, such as a premised IP-based PBX system or a network-based IP Centrex system, that is accessed over a data network. For example, users at terminals 110 can user private dialing plans and access enhanced services implemented by the voice server 154. A gateway NCG 182 couples the mobile backbone 120 to the voice server 154 by communicating with the mobile backbone using conventions mobile telephone protocols (e.g., IS-41, GSM), and by communicating with the voice server 154 using Internet Protocol (IP) based signaling, for example, using the Session Initiation Protocol (SIP) from control signaling and the Real Time Protocol (RTP) for audio data.

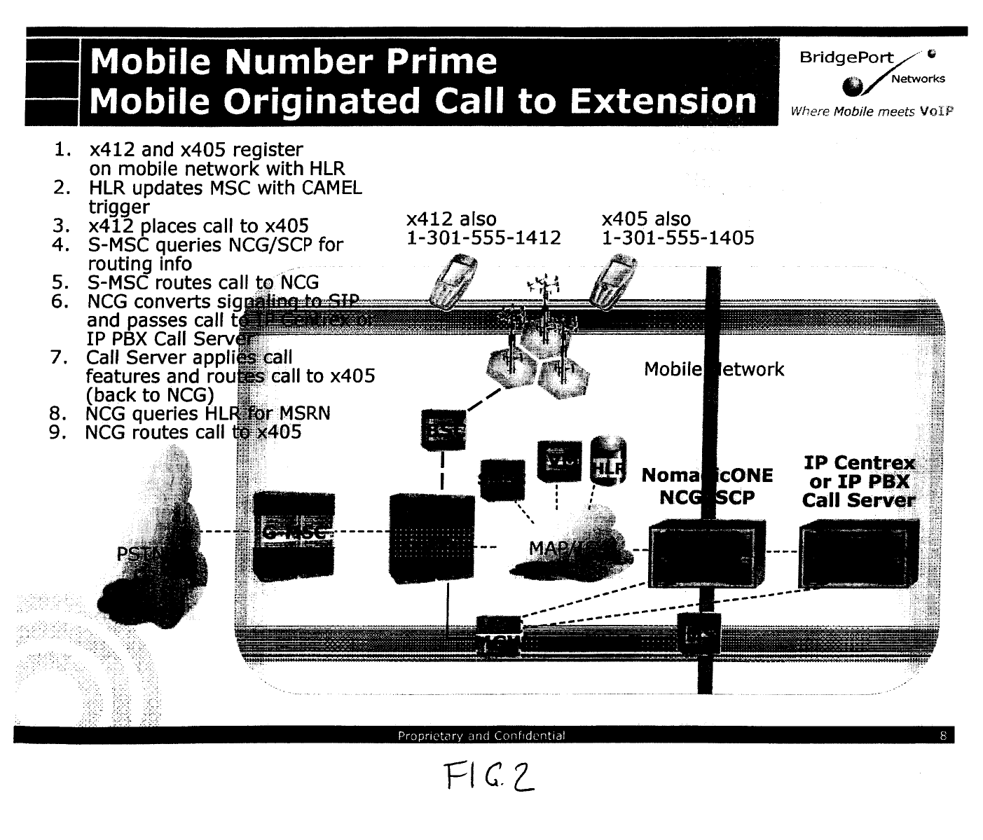

IP PBX and Centrex vendors would like to make their feature sets available to users with mobile handsets on a mobile telephone network. To provide features while a call is being setup (such as voice mail access or no-answer transfer), calls involving such users are routed through the voice server 154, which may for example be an Enterprise IP PBX of IP Centrex server. The gateway NCG 182 plays a role in this setup by reacting to WIN/CAMEL trigger messages from the cellular network and using those messages to route a subscriber's calls to the voice server. A sequence of interchanges between elements in the communication system for the purpose of call setup is shown in FIG. 2.

The approach illustrated in FIG. 2 works for features that occur when a call is being setup, but many advanced features, such as call transfer, require signaling exchanges between the mobile handset and the PBX/Centrex call server to occur in the middle of an ongoing call. An IP PBX/Centrex normally provides these services by signaling directly with devices using a protocol like SIP, but in this scenario there is only a voice connection between the PBX/Centrex and the mobile handset, so it is difficult or impossible for a PBX/Centrex to provide mid-call services.

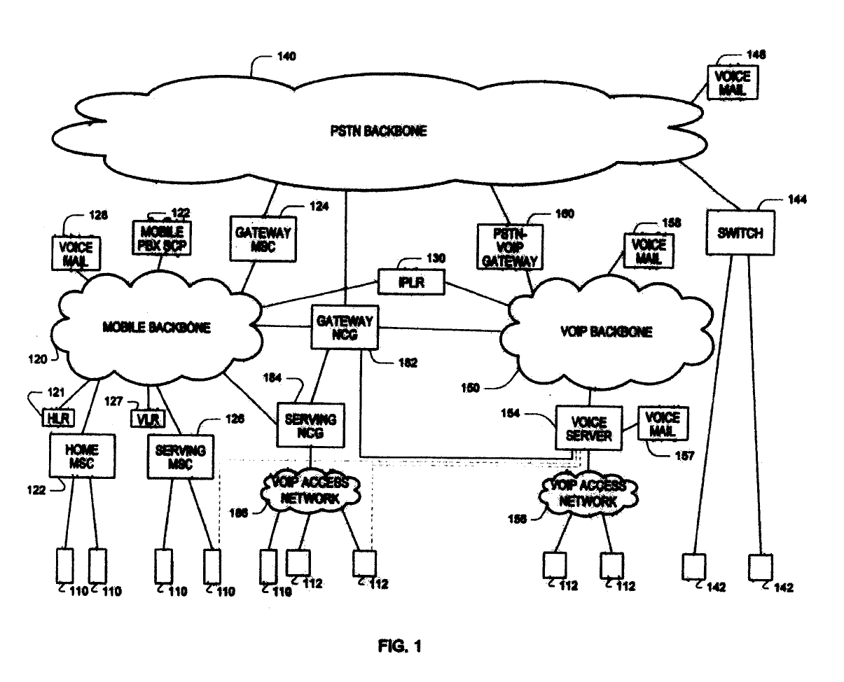

Referring back to FIG. 1, the gateway NCG 182 is already mediating between the PBX/Centrex and mobile network. It is desirable for the gateway NCG to provide cellular enterprise users access to mid-call features in a way that is transparent to the PBX/Centrex by emulating the mid-call actions a directly connected device would use. To do this, users need a way to signal the “mid-call” requests from the mobile handset 110 to the gateway NCG 182.

As described in incorporated applications Ser. No. 11/492,698 and PCT/US2006/028755, one way to signal “mid-call” requests is to encode them in the audio path between the mobile telephone 110 and the gateway NCG 182, for example, as DTMF digits that are interpreted and converted to their corresponding PBX/Centrex signaling (e.g., using the SIP protocol) by the gateway NCG.

Although such in-band DTMF-based signaling can provide access to mid-call features, alternative ways of signaling can provide certain advantages. Three alternatives for signaling mid-call actions to the gateway NCG are described below. In each case a cellular feature that can occur in the middle of a call is used to signal the mid-call request to the NCG. The first uses an added call attempt (in CDMA the additional call attempt implies Three-Way Calling, in GSM this is simply a second call) as a way to deliver mid-call requests using the same WIN/CAMEL triggering mechanism described above. The second is a similar approach, but uses SMS messaging to signal the request to the NCG during a call (it should be noted that if the SMS approach proves viable, it could also supplant the need for WIN/CAMEL triggers). The third alternative uses a GSM feature called USSD (Unstructured Supplemental Service Data), which allows feature requests from a subscriber to be passed transparently to a USSD service platform.

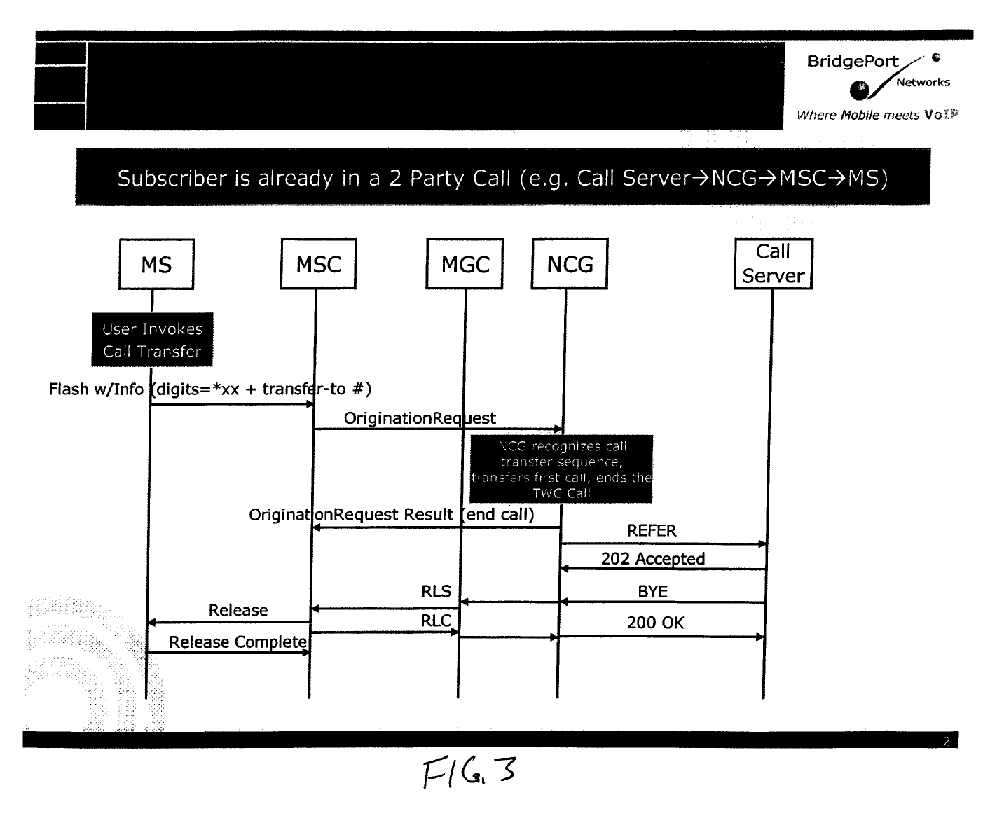

In GSM and CDMA it is possible to place an additional call during an existing call. In CDMA, this is normally done to establish a Three-Way call; in GSM a second call is placed. In this first alternative, the additional call attempt is used to signal “mid-call” requests to the NCG using special dialing sequences such as a *xx sequence . The additional call originations causes the same type WIN/CAMEL trigger to be sent to the NCG as occur during the initial call setup. Therefore, the NCG receives the mid-call triggers for special mid-call requests as well. When the NCG receives a trigger for a mobile telephone for which it is already mediating a call, instead of setting up a call, the NCG applies the appropriate mid-call request to a call in progress, for example, based on the digits dialed at the mobile telephone. An example of this approach is shown in FIG. 3.

As an example of this approach, when the mobile user dials the three-way call using a special “star” code, a WIN OriginationRequest message is sent by the mobile network to the NCG. If the NCG recognizes this sequence, then instead of setting up the new call, it will end that call (i.e., the additional call that the mobile network thinks was requested by the user) and applies the requested actions to the initial call (in this case sending a REFER message to the PBX/Centrex for the first call to invoke a call transfer request). (Depending on the user experience, it may be necessary to first route the additional call to the NCG prior to ending it so that the user does not hear or see confusing error messages).

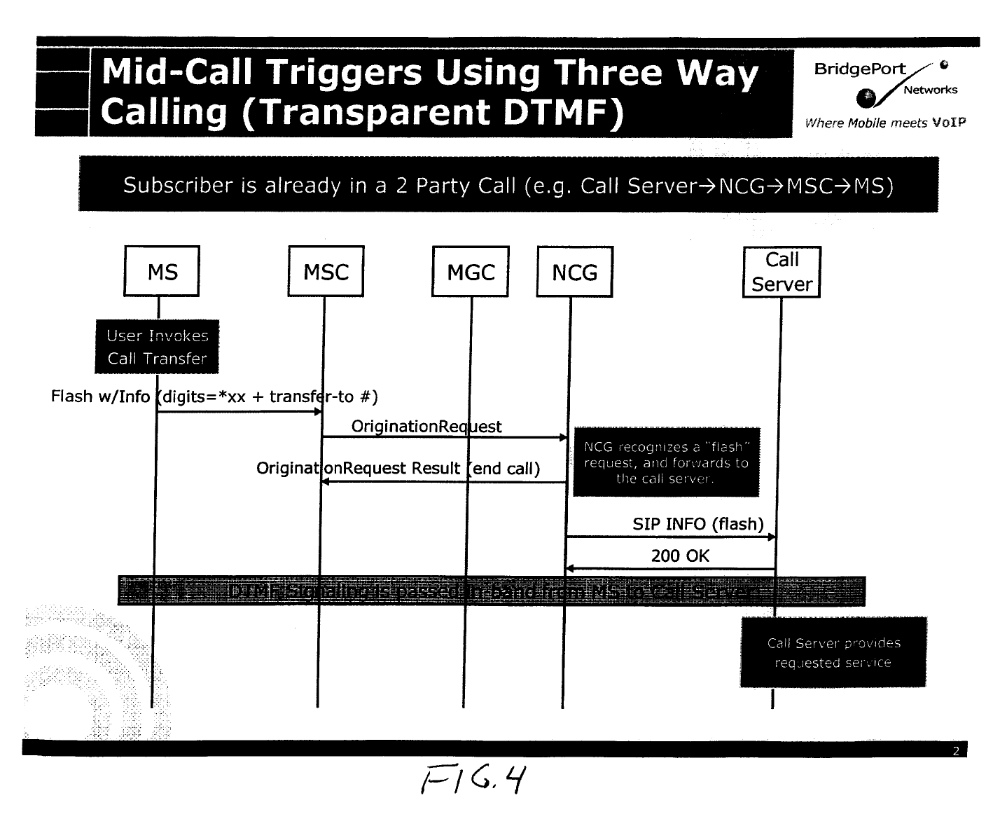

In the above example, the NCG is aware of the specific feature request. In a variant of this approach, for PBX/Centrex call servers that support mid-call DTMF features, the NCG could simply signal the proper “flash” message, which would tell the call server to collect and interpret DTMF digits from the subscriber. This variant is illustrated in FIG. 4.

Advantages of this first approach include one or more of not requiring ongoing DTMF monitoring in calls by the gateway NCG, limiting of extra signaling only to when mid-call triggers are needed, and signaling sequences for triggers that can be short enough to remember, so no client changes would be needed. A limitation of certain implementations of this first approach is that they may “use up” a three-way calling on the handset, so it may not be possible to mid-call trigger during an existing CW/TWC call (note however that this is only an issue if the MSC's TWC multiple line calling features are is used. This approach allows the PBX/Centrex three-way calling features to be used).

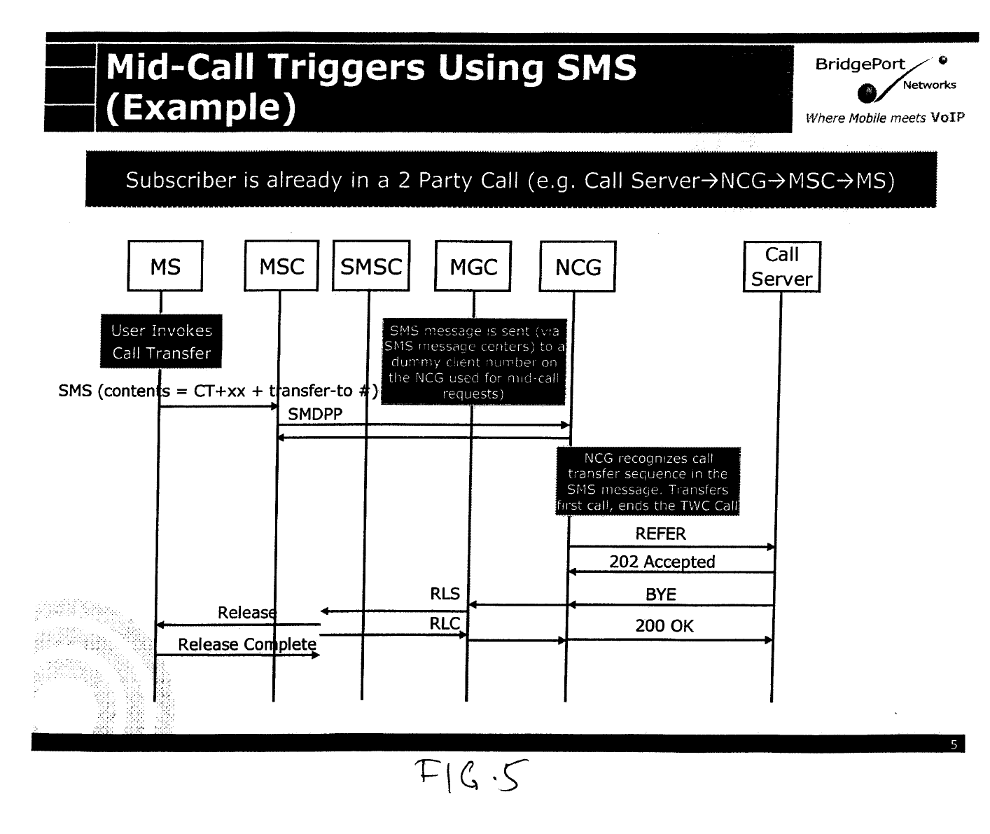

The second approach is similar to the first approach described above, but uses SMS messaging to signal the mid-call request to the gateway NCG in response to a user input. An application executing on the mobile handset sends an SMS to a special destination number that identifies the NCG. This message is sent (via the mobile subscriber's and NCG's SMSC/MC) to the NCG, which then applies the same mid-call signaling as in the previous examples. An example is shown in FIG. 5

An advantage of this second approach over the first approach is that it is still possible to use the MSC's TWC and CW features. A possible disadvantage of this approach is that it requires a special application in the handset to send the SMS message—when using TWC, it is possible for users to dial the start code themselves, but it would likely be too awkward to send a specially encoded SMS message. Also, to get the SMS messages to the NCG would require a “dummy” SMS account on the NCG, and there is added cost to deliver the SMS message to/from the subscriber (though mid-call features are relatively infrequent). Another possible concern is the delay when sending the SMS message, since it needs to be sent within a second or two to provide an adequate user experience, and SMS message delivery times may exceed that (a possible way to avoid this delay is to configure the NCG as the subscriber's MC/SMSC).

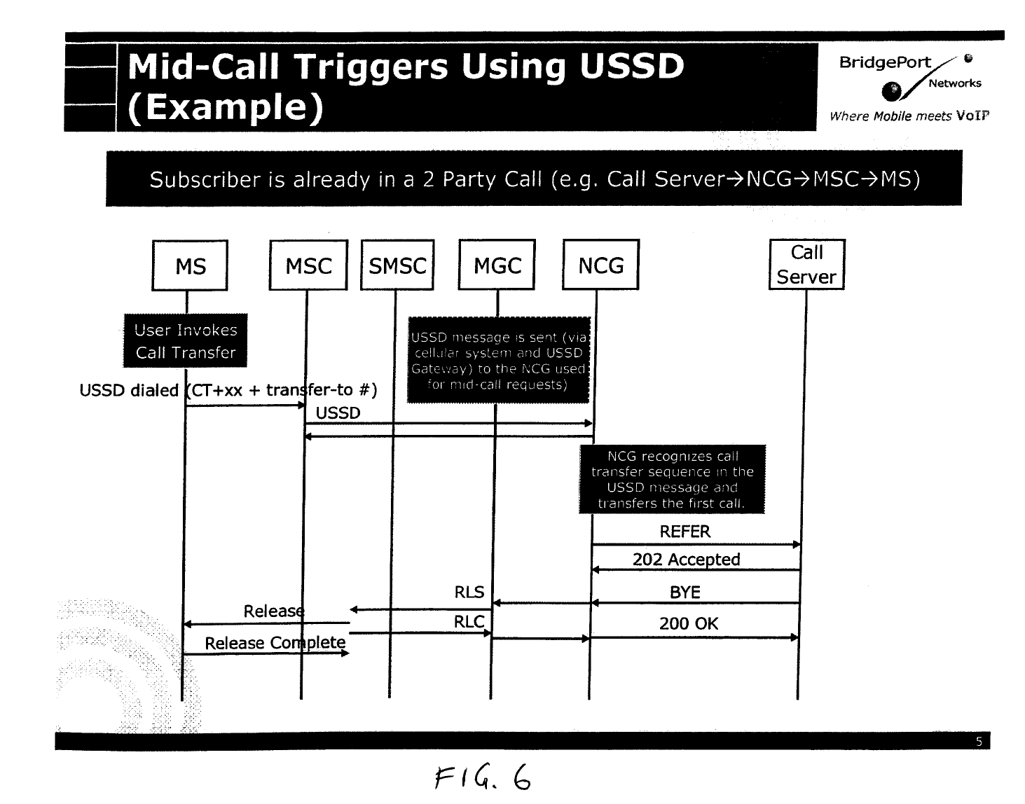

The third approach is similar to the second approach. GSM systems have feature called USSD (Unstructured Supplemental Service Data) that allows feature requests from a subscriber to be passed transparently to a USSD service platform. Since USSD requests can occur during an active call, these can be used to signal mid-call requests. The cellular network can be configured to send particular USSD requests representing mid-call requests to the NCG, and it can then implement the mid-call signaling with the PBX or Centrex. An example is shown in FIG. 6.

This approach avoids the delays associated with SMS messaging, and it doesn't require an extra call. A possible disadvantage of this third approach is that it is not available on CDMA systems, which currently have no USSD equivalent.

It is to be understood that the foregoing description is intended to illustrate and not to limit the scope of the invention, which is defined by the scope of the appended claims. Other embodiments are within the scope of the following claims.

What is claimed is:

1. A method for accessing a mid-call feature of a voice call server comprising:
(a) during a call with a mobile terminal via a mobile telephone network, passing a voice call signal associated with a mid-call feature from the mobile terminal over a mobile telephone network to a first communication system; and
(b) at the first communication system, converting the voice call signal to a data call signal and transmitting the data call signal to a second communication system over a data network.

2. The method of claim 1 further comprising:
(c) providing the mid-call feature in response to receipt of the data call signal at the second communication system.

3. The method of claim 1 wherein passing the voice call signal from the mobile terminal to the first communication system comprises passing a signal for establishing a multiparty call from the mobile terminal to the mobile telephone network.

4. The method of claim 3 wherein passing the voice call signal from the mobile comprises receiving the signal for establishing a multiparty call and notifying the first communication system.

5. The method of claim 1 wherein passing the voice call signal from the mobile terminal to the first communication system comprises passing a short message service (SMS) message from the mobile terminal to the first communication system.

6. The method of claim 1 wherein passing the voice call signal from the mobile terminal to the first communication system comprises passing a GSM unstructured supplementary services data (USSD) message from the mobile terminal to the first communication system.

7. The method of claim 1 wherein the first communication system comprises a gateway between the voice network and the data network.

8. The method of claim 1 wherein the second communication system comprises one of a private branch exchange system (PBX), an IP-based PBX, an IP Centrex, and a softswitch.

9. The method of claim 1 wherein the data call signal comprises a Session Initiation Protocol (SIP) message.

10. The method of claim 1 wherein the voice call signal associated with a mid-call feature comprises at least one of an IS-41 and a Wireless Intelligent Network (WIN) signal.

11. The method of claim 1 wherein the voice call signal associated with a mid-call feature comprises at least one of an GSM MAP, a GSM CAMEL, and a GSM USSD signal.

12. A system comprising:
a first communication system coupled to a mobile telephone network and to a data network configured to
receive from the mobile terminal over the mobile telephone network, during a call with a mobile terminal via a mobile telephone network, a voice call signal associated with a mid-call feature,
convert the voice call signal to a data call signal, and
transmit the data call signal to a second communication system over the data network.

13. The system of claim 12 further comprising the second communication system, configured to provide the mid-call feature in response to receipt of the data call signal.

14. Software embodied on a computer-readable medium comprising instructions for causing a processing system to:
process a voice call signal received over a mobile telephone network during a call with a mobile terminal via a mobile telephone network, the voice call signal being associated with a mid-call feature from the mobile terminal;
wherein the processing of the voice call signal includes converting the voice call signal to a data call signal and transmitting the data call signal to a second communication system over a data network.
